(19) United States
(12) Patent Application Publication
(10) Pub. No.: US 2024/0034560 A1
(43) Pub. Date: Feb. 1, 2024

(54) OBJECT RECOGNITION WAREHOUSING METHOD

(71) Applicant: TAIWAN TRUEWIN TECHNOLOGY CO., LTD., Hsinchu (TW)

(72) Inventor: Yu-Chen HSIEH, Hsinchu (TW)

(21) Appl. No.: 17/873,222

(22) Filed: Jul. 26, 2022

(51) Int. Cl. B65G 1/137; G06Q 10/08; G06V 20/64; G06V 10/764

(52) U.S. Cl. CPC B65G 1/1371; B65G 1/1373; G06Q 10/087; G06V 20/64; G06V 10/764

(57) ABSTRACT

Disclosed is an Object Recognition Warehousing Method for STORE or FETCH an object through a pretrained Object Recognition Model (ORM). Image of an object is taken by an image sensor for Object Recognition, and system automatically provides options of classification and labelling A physical object without package is recognized for STORE according to the present invention.

### BACKGROUND

### Technical Field

The present invention relates to a warehousing method, particularly relates to an Object Recognition Warehousing Method using a type of artificial intelligence model known as Object Recognition Model (ORM).

### Description of Related Art

FIG. 1 is a traditional prior art.

FIG. 1 shows a traditional warehousing method, including the steps:

Step 1: STORE starting;

Step 2: Turning on a barcode reader;

Step 3: Scanning a barcode of a package; a barcode database is provided for the method to use; the barcode database comprises information of barcodes versus Objects;

(Additional step/steps), and

Ending the process.

The disadvantage of this conventional method is that it is necessary to create first a barcode database for the system to use; the barcode database comprises the information with regards to Barcodes versus Packages. A unique barcode need to be printed out and attached to corresponding packages one by one in advance, A barcode scanner scans the unique barcode of the package before the package can be stored. The traditional warehousing method requires higher cost for manpower and hardware requirements, and it is more expensive and a time-consuming warehousing system.

The present invention firstly conceives for a physical object without package, or with a transparent package, to be recognized using continuously trained Object Recognition Model (ORM) for warehousing purpose.

### BRIEF DESCRIPTION OF THE DRAWINGS

FIG. 1 is a traditional prior art.

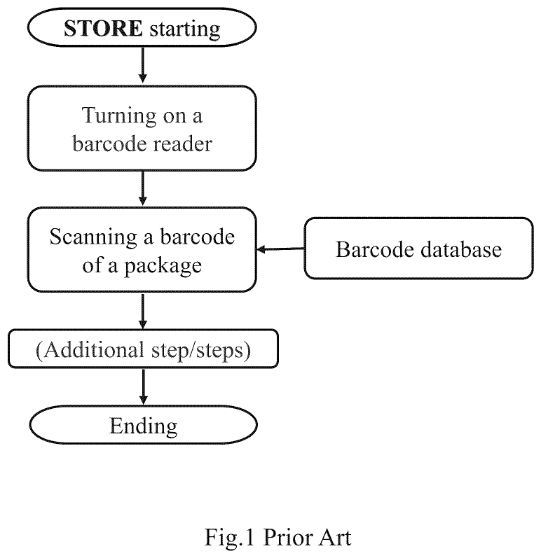

FIG. 2 is a first embodiment for object recognition according to the present invention.

FIG. 3 is a second embodiment for object recognition according to the present invention.

FIG. 4 is a first embodiment for fetching an object according to the present invention.

FIG. 5 is a second embodiment for fetching an object according to the present invention.

FIG. 6 is a method for training an artificial intelligence Model for Object Recognition (ORM) according to the present invention.

### DETAILED DESCRIPTION OF THE INVENTION

System uses an Object recognition Model (ORM), a kind of artificial intelligence model, to provide labeling suggestions of an object or objects in real time. The system performs predictions and updates labeling suggestions at a certain refresh rate, taking an image captured by the image sensor as input on each update, Updates will stop when user selects from one of them or providing the system with one themselves. For example, the labeling suggestions provided by the system for a steak knife after 3 seconds of updating might be “butter knife” and “steak knife”, user can then proceed to select one of the suggestions as the label of current object or manually type in “knife” as the label.

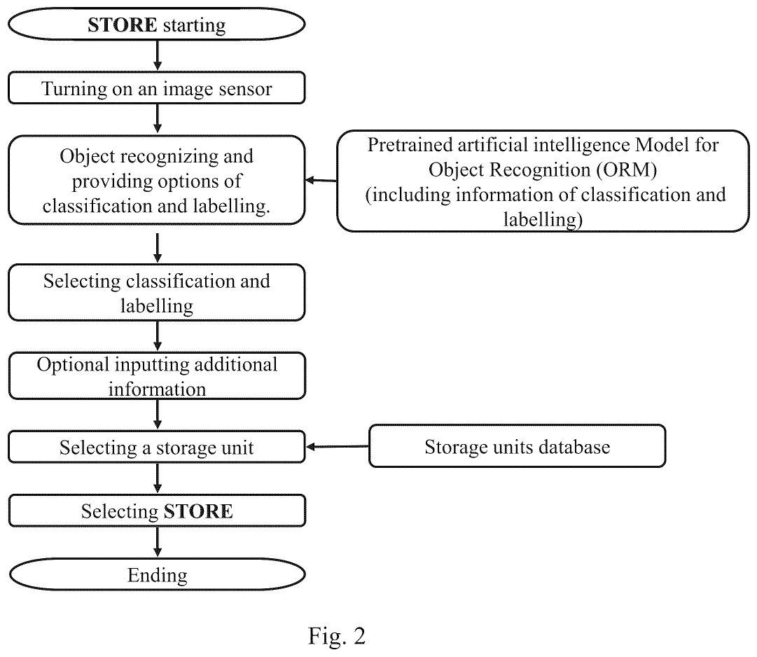

FIG. 2 is a first embodiment for object recognition according to the present invention.

The first embodiment for object recognition comprises the steps:
(1) STORE starting;
(2) Turning on an image sensor, to capture one or more images of a candidate object to be recognized by the system;
(3) Object recognizing in real time, and providing options of classification and labelling; A pretrained artificial intelligence Model for Object Recognition (ORM) is provided for the method to use, the model also comprises information of classification and labelling;
(4) Selecting classification and labelling;
(5) Optional inputting additional information;
(6) Selecting a storage unit; a storage unit database is provided for the method to use;
(7) selecting STORE; and
(8) Ending.

The recognized object s then stored in the specified storage unit by user or by a linked robot.

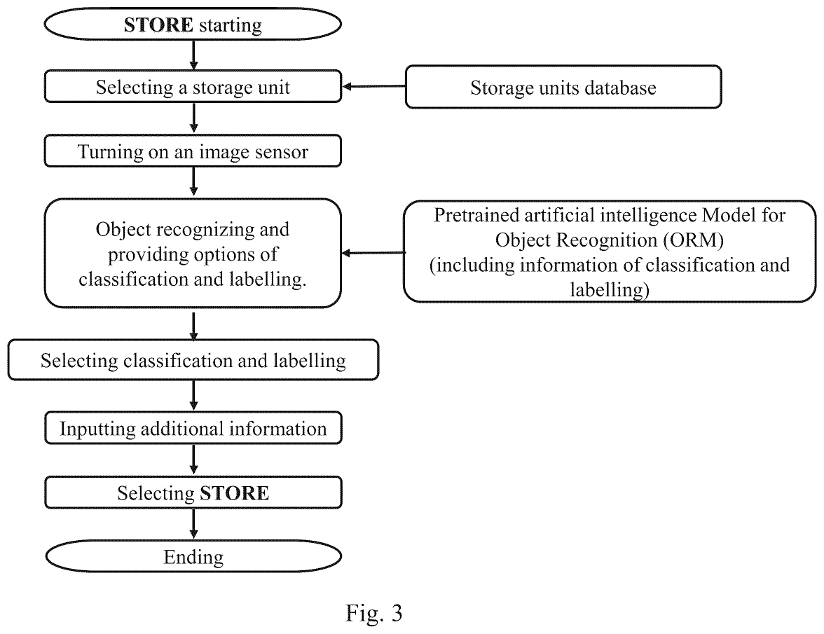

FIG. 3 is a second embodiment for object recognition according to the present invention.

The second embodiment for object recognition comprises the steps:
(1) STORE starting;
(2) Selecting a storage unit; a storage unit database is provided for the method to use;
(3) Turning on an image sensor, to capture one or more images of a candidate object to be recognized by the system;
(4) Object recognizing in real time, and providing options of classification and labelling; A pretrained artificial intelligence Object Recognition Model (ORM) is provided for the method to use, the model comprises the information of classification and labelling;
(5) Selecting classification and labelling;
(6) Optional inputting additional information;
(7) selecting STORE; and
(8) Ending.

The recognized object is then stored in the specified storage unit by user or by a linked robot,

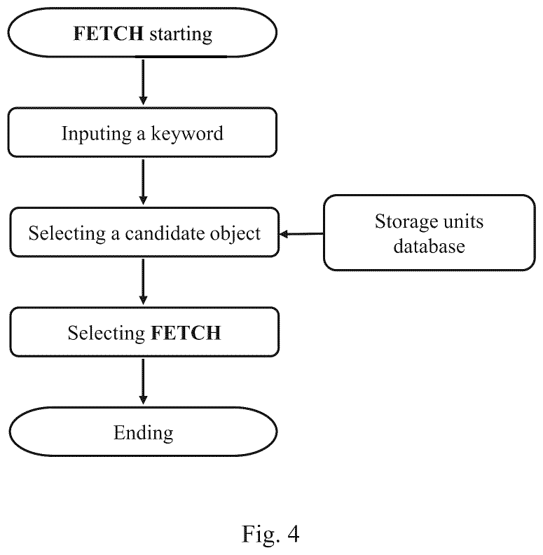

FIG. 4 is a first embodiment for fetching an object according to the present invention.

The first embodiment for fetching object comprises the steps:
(1) FETCH starting;
(2) Inputting a keyword for a candidate object to be fetched;
(3) Selecting an object to fetch; a storage unit database with the information of stored objects versus storage units is provided for the method to use;
(4) Selecting FETCH; and
(5) Ending.

The candidate object is then taken out from the specified storage unit by user or by a linked robot.

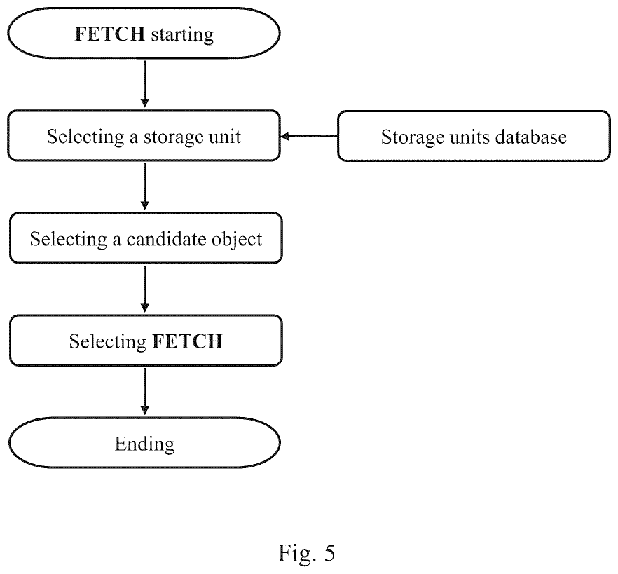

FIG. 5 is a second embodiment for fetching an object according to the present invention.

The second embodiment for fetching object comprises the steps:
(1) FETCH starting;
(2) Selecting a storage unit; a storage unit database with the information for stored objects versus storage units is provided for the method to use;
(3) Selecting an object;
(4) Selecting FETCH; and
(5) Ending.

The candidate object is then taken out from the specified storage unit by user or by a linked robot.

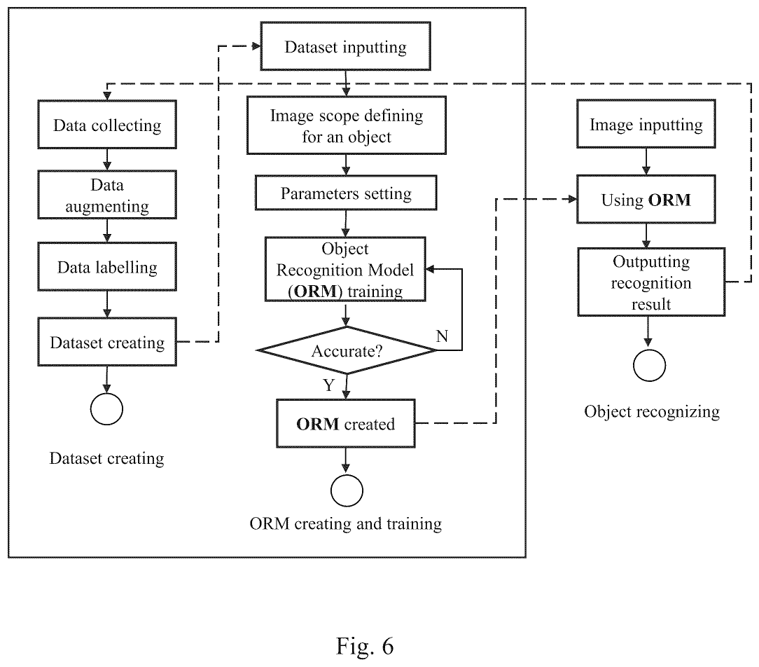

FIG. 6 is a method for training an artificial intelligence Model for Object Recognition (ORM) according to the present invention.

A method for an Object Recognition Model (ORM) created and trained by artificial intelligence according to the present invention comprises a process of (a) dataset creating, and (b) ORM creating and training.

FIG. 6 shows the dataset creating process, which comprises:
(1) Data collecting, to collect characteristics information for a specific object;
(2) Data augmenting, to increase the amount of data by adding slightly modified copies of already existing data or newly created synthetic data from existing data. It acts as a regularizer and helps reduce overfitting when training a machine learning model to achieve higher accuracy; and
(3) Data labelling: Annotate the features for an object to be identified;
(4) Dataset creating.

FIG. 6 also shows a method for ORM creating and training, which comprises:
(1) Dataset inputting;
(2) Image scope defining for an object;
(3) Parameters setting;
(4) Object Recognition Model (ORM) training; and
(5) Determining whether it is accurate?
(6) If yes, an ORI is created; if no, go back to previous step;

FIG. 6 also shows an Object recognizing process according to the present invention, which comprises:
(1) image inputting; image of the candidate object is input for Object Recognition;
(2) Using ORM; the object is recognized by using ORM created by artificial intelligence; and
(3) Outputting recognition result.

The image and data obtained from the candidate object through the image sensor be fed back to the system for training the ORM to increase its accuracy.

While seven 1 embodiments have been described by way of example, it will be apparent to those skilled in the art that various modifications may be configured without departs from the spirit of the present invention. Such modifications are all within the scope of the present invention, as defined by the appended claims.

What is claimed is:

1. An object recognition warehousing method, comprising:
(1) STORE starting;
(2) Turning on an image sensor, to capture one or more images of a candidate object to be recognized by the system;
(3) Object recognizing in real time, and providing options of classification and labelling; an Objection Recognition Model (ORM) created and trained by artificial intelligence is provided for the method to use, including information of classification and labelling;
(4) Selecting classification and labelling;
(5) Optional inputting additional information;
(6) Selecting a storage unit; a storage unit database is provided for the method to use;
(7) selecting STORE; and
(8) Ending.

2. The method as claimed in claim 1 further includes a FETCH method comprises:
(1) FETCH starting;
(2) Optional inputting a keyword for a candidate object to be fetched;
(3) Selecting an object; a storage unit database with the information for stored objects is provided for the method to use;
(4) Selecting FETCH; and
(5) Ending.

3. The method as claimed in claim 1 further includes a FETCH method comprises:
(1) FETCH starting;
(2) Selecting a storage unit; a storage unit database with the information for stored objects is provided for the method to use;
(3) Selecting an object;
(4) Selecting FETCH; and
(5) Ending.

4. An object recognition warehousing method, comprising:
(1) STORE starting;
(2) Selecting a storage unit; a storage unit database is provided for the method to use;
(3) Turning on an image sensor, to capture one or more images of a candidate object to be recognized by the system;
(4) Object recognizing in real time, and providing options of classification and labelling; an Objection Recognition Model (ORM) created and trained by artificial intelligence is provided for the method to use, including information of classification and labelling;
(5) Selecting classification and labelling;
(6) Optional inputting additional information;
(7) selecting STORE; and
(8) Ending.

5. The method as claimed in claim 4 further includes a FETCH method comprises:
(1) FETCH starting;
(2) Inputting a keyword for a candidate object to be fetched;
(3) Selecting an object; a storage unit database with the information for stored objects is provided for the method to use;
(4) Selecting FETCH; and
(5) Ending.

6. The method as claimed in claim 4 fluffier includes a FETCH method comprises:
(1) FETCH starting;
(2) Selecting a storage unit; a storage unit database with the information for stored objects is provided for the method to use;
(3) Selecting an object;
(4) Selecting FETCH; and
(5) Ending.

7. The method as claimed in claim 1, wherein
the dataset creating process further comprises:
(1) Data collecting, to collect characteristics information for a specific object;
(2) Data augmenting, to increase the amount of data by adding slightly modified copies of already existing data or newly created synthetic data from existing data.
It acts as a regularizer and helps reduce overfitting when training a machine learning model to achieve higher accuracy; and
(3) Data labelling: Annotate the features for an object to be identified; and
(4) Dataset creating; and wherein,
the ORM creating and training process further comprises:
(1) Dataset inputting;
(2) Image scope defining for an object;
(3) Parameters setting;
(4) Object Recognition Model (ORM) training; and
(5) Determining whether it is accurate? and
(6) If yes, an ORM is created; if no, go back to previous step.

8. The method as claimed in claim 4, wherein
the dataset creating process further comprises:
(1) Data collecting, to collect characteristics information for a specific object;
(2) Data augmenting, to increase the amount of data by adding slightly modified copies of already existing data or newly created synthetic data from existing data.
It acts as a regularizer and helps reduce overfitting when training a machine learning model to achieve higher accuracy; and
(3) Data labelling: Annotate the features for an object to be identified; and
(4) Dataset creating; and wherein,
the ORM creating and training process further comprises:
(1) Dataset inputting;
(2) Image scope defining for an object;
(3) Parameters setting;
(4) Object Recognition Model (ORM) training; and
(5) Determining whether it is accurate? and
(6) If yes, an ORM is created; if no, go back to previous step.
